(19) United States
(12) Patent Application Publication
(10) Pub. No.: US 2022/0323930 A1
(43) Pub. Date: Oct. 13, 2022

(54) CARBON DIOXIDE ADSORBENT BASED ON HYDROPHOBIC SILANE-COATED AMINE-FUNCTIONALIZED MOF/ALUMINA COMPOSITE

(71) Applicant: KOREA UNIVERSITY RESEARCH AND BUSINESS FOUNDATION, Seoul (KR)

(72) Inventors: Chang Seop HONG, Seoul (KR); Jong Hyeak CHOE, Seoul (KR)

(73) Assignee: KOREA UNIVERSITY RESEARCH AND BUSINESS FOUNDATION, Seoul (KR)

(21) Appl. No.: 17/615,652

(22) PCT Filed: May 28, 2020
(86) PCT No.: PCT/KR2020/006909

§ 371 Date: Dec. 1, 2021

(30) Foreign Application Priority Data
Jun. 1, 2019 (KR) 10-2019-0065015

(51) Int. Cl. B01J 20/22; B01J 20/08; B01J 20/28; B01J 20/30; B01J 20/32

(52) U.S. Cl. CPC B01J 20/226; B01J 20/08; B01J 20/28016; B01J 20/3021; B01J 20/3085; B01J 20/3293; B01J 20/3206; B01J 20/3204; B01J 20/3231; B01J 20/3217

(57) ABSTRACT

The present invention relates to a carbon dioxide adsorbent based on a hydrophobic silane-coated amine-functionalized MOF/alumina composite and, more specifically, to a carbon dioxide adsorbent based on a hydrophobic silane-coated amine-functionalized MOF/alumina composite, capable of maintaining structural stability by means of the moisture present in exhaust gas, and thus can effectively capture carbon dioxide in a real fluidized bed. According to the present invention, provided are a carbon dioxide adsorbent and a preparation method therefor, the carbon dioxide adsorbent being capable of maintaining structural stability by means of the moisture present in exhaust gas since the surface of a porous metal-organic framework/alumina oxide composite is coated with hydrophobic silane.

### TECHNICAL FIELD

The present invention relates to a carbon dioxide adsorbent based on a hydrophobic silane-coated amine-functionalized MOF/alumina composite, and more specifically to a carbon dioxide adsorbent based on a hydrophobic silane-coated amine-functionalized MOF/alumina composite that can effectively reduce the amount of energy required for regeneration after adsorption and desorption of carbon dioxide and maintain its structural stability against water present in flue gas, thus being effective in capturing carbon dioxide in a real fluidized bed.

### BACKGROUND ART

30-40% of carbon dioxide (CO₂) emissions, the main cause of global warming, are from thermal power plants. The partial pressure of CO₂ in flue gas is 150 mbar. In a fluidized bed for effective adsorption of CO₂ gas by a solid adsorbent, CO₂ adsorption proceeds from the bottom of the bed and the partial pressure of CO₂ is reduced to 15 mbar at the top of the bed where a CO₂ capture rate of 90% is reached. Therefore, solid adsorbents used in fluidized beds should be able to adsorb CO₂ over a wide range of concentrations.

After adsorption, existing adsorbents are transferred to a regenerator for reactivation. However, efficient desorption of a high concentration of CO₂ is not achieved in the regenerator and at a low temperature, limiting the reuse of the adsorbents. Thus, considerable research has been conducted on adsorbents that have a high adsorptivity for a low concentration of carbon dioxide and readily desorb the captured carbon dioxide at a high concentration.

Metal-organic frameworks (MOFs) as solid adsorbents are crystalline solids in which the ligands are coordinated to the metal and have the advantages of large surface area and controllable porosity. Due to their advantages, MOFs are currently being investigated as effective absorbents for CO₂ capture. In addition, the introduction of amino groups onto MOFs was reported to achieve dramatically improved adsorption capacity through chemical bonds between the amino groups and the carbon atoms of carbon dioxide molecules.

However, previously developed MOFs should maintain their structural stability under humid conditions for application to actual carbon dioxide capture processes. Carbon dioxide is one of the leading causes of global warming and is mainly emitted from thermal power plants. Flue gas from power plants is composed of approximately 15% by volume of carbon dioxide, approximately 75% by volume of nitrogen, and approximately 10% by volume of other combustion gases. Water accounts for about 5-7% of the total volume of the combustion gases. When water vapor is present during adsorption of carbon dioxide by MOFs, water may replace the adsorbed carbon dioxide and the metal-ligand bonds may be broken, resulting in collapse of the MOF structures. Flue gas from power plants also contains trace amounts of acid gases such as sulfur dioxide (SO₂) and nitrogen dioxide (NO₂). The acid gases are converted to strong acids when meeting water, affecting the MOF structures. Consequently, these components affecting the MOF structures have a direct influence on the adsorptivity of the MOF structures for carbon dioxide. Thus, there is a need to develop a carbon dioxide adsorbent that can maintain its structural stability against water and acid gases present in flue gas from power plants.

### DETAILED DESCRIPTION OF THE INVENTION

### Problems to be Solved by the Invention

The present invention has been made in an effort to solve the above-described problems, and an object of the present invention is to provide a carbon dioxide adsorbent that can maintain its structural stability against water.

### Means for Solving the Problems

An aspect of the present invention provides a carbon dioxide adsorbent including an amine-functionalized metal-organic framework (MOF)/alumina composite including an amine-functionalized porous MOF and aluminum oxide (Al₂O₃) bound to the metal ions of the amine-functionalized porous MOF wherein the surface of the composite is coated with a hydrophobic silane.

According to the present invention, the porous metal-organic framework may be selected from the group consisting of M₂(dobpdc), M₂(dobdc), M₂(m-dobdc), M₂(dondc), and M₂(dotpdc) where M is Mg, Ti, V, Cr, Mn, Fe, Co, Ni, Cu or Zn, dobpdc is 4,4′-dioxido-3,3′-biphenyldicarboxylate, dobdc is 2,5-dioxido-1,4-benzenedicarboxylate, m-dobdc is 4,6-dioxido-1,3-benzenedicarboxylate, dondc is 1,5-dioxide-2,6-naphthalenedicarboxylate, and dotpdc is 4,4′-dioxido-3,3′-triphenyldicarboxylate.

According to the present invention, the amine may be represented by Formula 1:

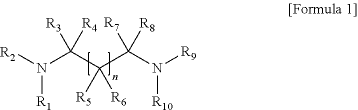

wherein R₁ to R₁₀ are each independently hydrogen or (CH₂)ₘ—CH₃, n is an integer from 1 to 20, and each m is independently an integer from 0 to 20, or Formula 2:

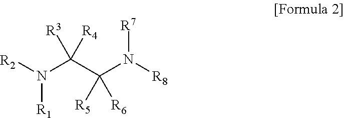

wherein R₁ to R₈ are each independently hydrogen or (CH₂)ₘ—CH₃ and each m is independently an integer from 0 to 20.

According to the present invention, the polyvalent amine may be ethylenediamine, 1-methylethylenediamine, 1,1-dimethylethylenediamine or N-ethylethylenediamine.

According to the present invention, the hydrophobic silane may be represented by Formula 3:

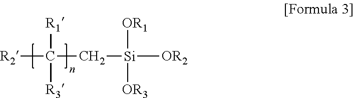

wherein R₁ to R₃ and R₁′ to R₃′ are each independently hydrogen or (CH₂)ₘ—CH₃ and n and m are each independently an integer from 0 to 20.

Specifically, the hydrophobic silane may be selected from the compounds represented by Formulae 4 to 9:

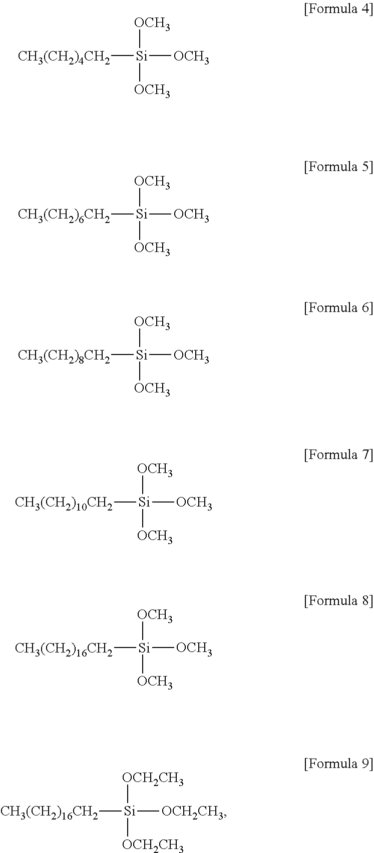

and mixtures thereof.

According to the present invention, the hydrophobic silane may be coated in an amount corresponding to a weight ratio of 3:1 to 10:1 to the composite.

### Effects of the Invention

The surface coating of the amine-functionalized porous metal-organic framework/alumina composite with the hydrophobic silane allows the carbon dioxide adsorbent of the present invention to maintain its structural stability against water generated from flue gas.

### BRIEF DESCRIPTION OF THE DRAWINGS

FIG. 1 shows the results of an experiment for the establishment of optimal reaction conditions for introducing a hydrophobic silane to the surface of an amine-functionalized porous metal-organic framework/alumina composite (een-MOF/Al) prepared in Example 1.

FIG. 2 shows the effects of the numbers of carbon atoms in hydrophobic silanes introduced to the surface of an amine-functionalized porous metal-organic framework/alumina composite (een-MOF/Al) prepared in Example 1 on the long-term hydrophobicity of the composite.

FIG. 3 shows a PXRD pattern of an amine-functionalized porous metal-organic framework/alumina composite surface coated with a hydrophobic silane (een-MOF/Al—Si), which was prepared in Example 1.

FIG. 4 shows an IR spectrum of an amine-functionalized porous metal-organic framework/alumina composite surface coated with a hydrophobic silane (een-MOF/Al—Si), which was prepared in Example 1.

FIG. 5 shows surface (left) and cross-sectional (right) SEM-EDS images of an amine-functionalized porous metal-organic framework/alumina composite surface coated with a hydrophobic silane (een-MOF/Al—Si), which was prepared in Example 1.

FIG. 6 shows the results of XPS analysis for an amine-functionalized porous metal-organic framework/alumina composite surface coated with a hydrophobic silane (een-MOF/Al—Si), which was prepared in Example 1.

FIG. 7 shows nitrogen adsorption isotherms of een-MOF/Al and een-MOF/Al—Si prepared in Example 1 at 77K.

FIG. 8 shows carbon dioxide adsorption isotherms of een-MOF/Al—Si prepared in Example 1 at 40-120° C.

FIG. 9 shows thermogravimetric analysis curves of een-MOF/Al—Si prepared in Example 1 to find conditions for adsorption of carbon dioxide at a concentration of 15% (left) and conditions for desorption of carbon dioxide at a concentration of 100% (right).

FIG. 10 shows carbon dioxide adsorption isotherms of een-MOF/Al—Si prepared in Example 1 at 313-393K.

FIG. 11 shows the results of analyzing the long-term adsorption performance of een-MOF/Al—Si prepared in Example 1.

FIG. 12 shows water adsorption isotherms of een-MOF/Al and een-MOF/Al—Si prepared in Example 1 at 25° C.

FIG. 13 shows the results of evaluation of long-term water stability of een-MOF/Al (top) and een-MOF/Al—Si (bottom) prepared in Example 1.

FIG. 14 shows the contact angles and adsorption capacities of composites coated with hydrophobic silanes with different end groups.

### BEST MODE FOR CARRYING OUT THE INVENTION

The present invention will now be described in more detail.

The present invention intends to provide a carbon dioxide adsorbent that can effectively reduce the amount of energy required for regeneration after adsorption and desorption of carbon dioxide and maintain its structural stability against water, thus being suitable for use in a fluidized bed process.

Thus, the present invention provides a carbon dioxide adsorbent including an amine-functionalized metal-organic framework (MOF)/alumina composite including an amine-functionalized porous MOF and aluminum oxide (Al₂O₃) bound to the metal ions of the amine-functionalized porous MOF wherein the surface of the composite is coated with a hydrophobic silane.

The porous metal-organic framework may be selected from the group consisting of M₂(dobpdc), M₂(dobdc), M₂(m-dobdc), M₂(dondc), and M₂(dotpdc) where M is Mg, Ti, V, Cr, Mn, Fe, Co, Ni, Cu or Zn, preferably Mg, dobpdc is 4,4′-dioxido-3,3′-biphenyldicarboxylate, dobdc is 2,5-dioxido-1,4-benzenedicarboxylate, m-dobdc is 4,6-dioxido-1,3-benzenedicarboxylate, dondc is 1,5-dioxide-2,6-naphthalenedicarboxylate, and dotpdc is 4,4′-dioxido-3,3′-triphenyldicarboxylate.

The organic frameworks dobpdc, dobdc, m-dobdc, dondc, and dotpdc are represented by the following formulae:

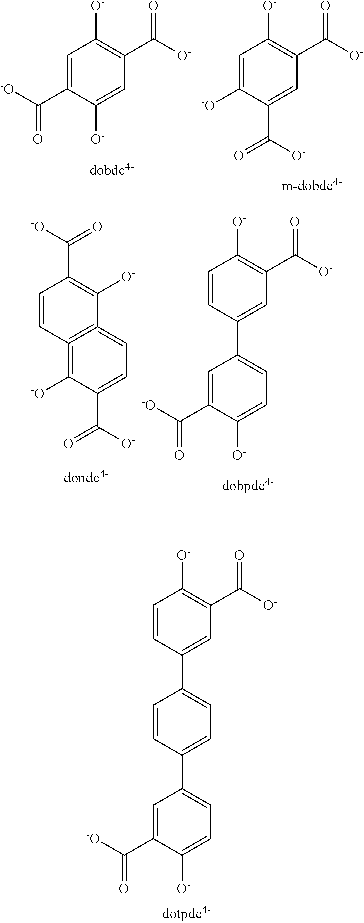

It is preferable that the porous metal-organic framework is functionalized with an amine containing one or more amino groups selected from primary to tertiary amino groups. The amine functionalization of the porous metal-organic framework allows the carbon dioxide adsorbent to capture even low concentrations of carbon dioxide. For capture carbon dioxide from the air, it is particularly preferable that a high density of amino groups are introduced into the cavities of the porous metal-organic framework. The introduction of the high-density amino groups leads to a marked improvement in the enthalpy of adsorption through the interaction between the amino groups and the carbon atoms of CO₂ molecules. This amine functionalization is achieved by grafting the amino groups onto the open metal sites of the porous metal-organic framework. The open metal sites act as Lewis acids. Primary amino groups containing two hydrogen atoms can be well coordinated to the open metal sites. The free amino radicals can effectively trap CO₂ entering the cavities.

Specifically, the amine may be represented by Formula 1:

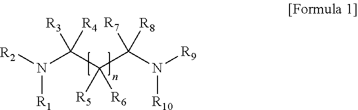

wherein R₁ to R₁₀ are each independently hydrogen or (CH₂)ₘ—CH₃, n is an integer from 1 to 20, and each m is independently an integer from 0 to 20, or Formula 2:

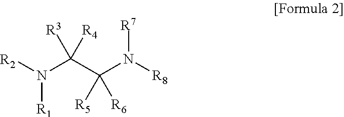

wherein R₁ to R₈ are each independently hydrogen or (CH₂)ₘ—CH₃ and each m is independently an integer from 0 to 20.

The amine represented by Formula 1 or 2 is preferably ethylenediamine, 1-methylethylenediamine, 1,1-dimethylethylenediamine or N-ethylethylenediamine, but is not necessarily limited thereto.

The introduction of the hydrophobic silane to the surface of the amine-functionalized MOF/alumina composite leads to an improvement in the water stability of the composite. The hydrophobic silane introduced to the surface of the amine-functionalized MOF/alumina composite is represented by Formula 3:

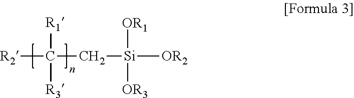

wherein R₁ to R₃ and R₁′ to R₃′ are each independently hydrogen or (CH₂)ₘ—CH₃ and n and m are each independently an integer from 0 to 20.

The hydrophobic silane may be selected from the compounds represented by Formulae 4 to 9:

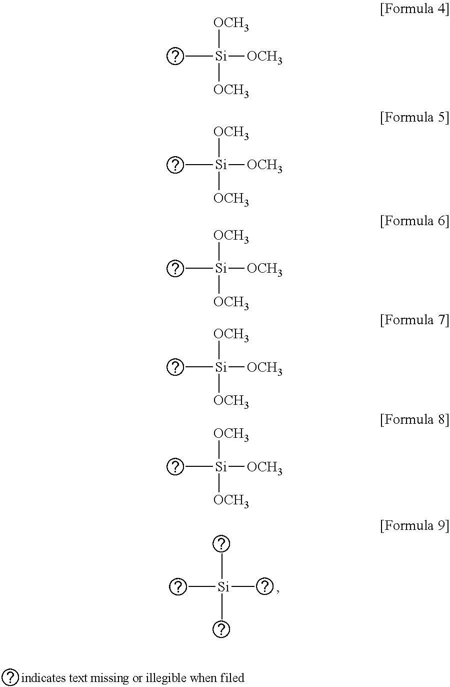

and mixtures thereof.

The introduction of the hydrophobic silane enhances the mechanical strength and water stability of the amine-functionalized MOF/alumina composite, and as a result, the carbon dioxide adsorbent of the present invention can maintain its adsorptivity for carbon dioxide even when reused. The hydrophobic silane is preferably coated in an amount corresponding to a weight ratio of 3:1 to 10:1, more preferably 3:1 5:1 to the composite, as can be seen from the results in the Examples section that follows.

### MODE FOR CARRYING OUT THE INVENTION

The present invention will be more specifically explained with reference to the following examples. It will be evident to those skilled in the art that these examples are merely for illustrative purposes and are not intended to limit the scope of the invention.

### Example 1. Production of Carbon Dioxide Adsorbent Including Amine-Functionalized Porous Metal-Organic Framework/Alumina Composite Surface Coated with Hydrophobic Silane

First, Mg₂(dobpdc) (300 g) and an alumina sol (334 g) were uniformly pulverized with a ball mill and dried with a spray dryer to obtain a spherical porous metal-organic framework/alumina composite (Mg₂(dobodc)/Al₂O₃, hereinafter abbreviated as “MOF/Al”). Next, the MOF/Al was annealed at 350° C. and allowed to react with N-ethylethylenediamine (een) in hexane at room temperature for 30 min. After completion of the reaction, the reaction mixture was filtered to afford an amine-functionalized porous metal-organic framework/alumina composite (een-MOF/Al) as a brown solid.

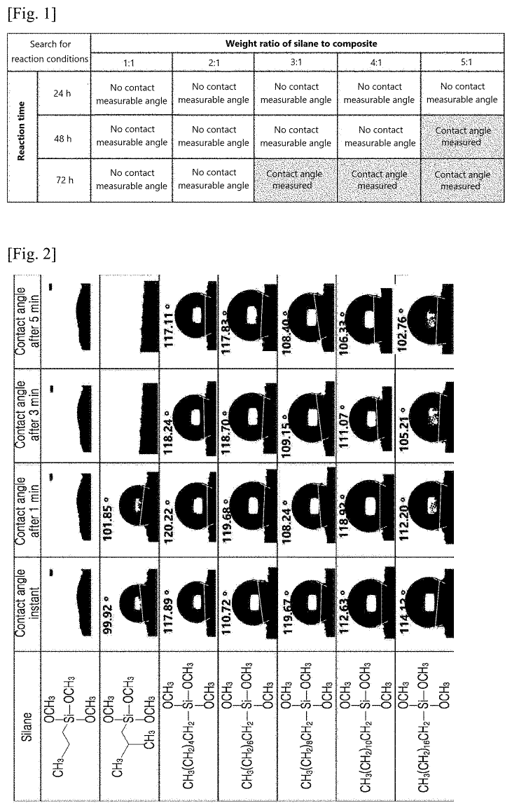

Next, octadecyl(trimethoxy)silane as a hydrophobic silane was introduced to the surface of the een-MOF/Al. The hydrophobic silane was used in amounts corresponding to weight ratios of 1-5:1 to the een-MOF/Al to establish reaction conditions for its introduction to the surface of the composite (een-MOF/Al). Optimal reaction conditions were determined by varying the reaction time and temperature. The results are shown in FIG. 1. As shown in FIG. 1, when the silane was introduced in amounts corresponding to weight ratios of 1:1 and 2:1 to the een-MOF/Al, no contact angles were measurable even after 72 hours of reaction. When the silane was introduced in amounts corresponding to weight ratios of 3:1 and 4:1 to the een-MOF/Al, contact angles could be measured only when the reaction time was 72 h. When the silane was introduced in an amount corresponding to a weight ratio of 5:1 to the een-MOF/Al, contact angles could be measured from when the reaction time was 48 h. These results demonstrate that it is preferable to introduce the silane in amounts corresponding to weight ratios of 3:1 to 5:1, particularly a weight ratio of 5:1, to the een-MOF/Al. Therefore, the amine-functionalized porous metal-organic framework/alumina composite surface coated with the silane in an amount corresponding to a weight ratio of 5:1 to the composite (een-Mg₂(dobodc)/Al₂O₃—Si, hereinafter abbreviated as “een-MOF/Al—Si”) was used for further experiments.

Specifically, the een-MOF/Al—Si coated with the silane in an amount corresponding to a weight ratio of 5:1 to the een-MOF/Al was prepared by the following procedure. First, the een-MOF/Al composite was weighed (1 g) and placed in a 100 mL round-bottom flask. Thereafter, hexane (20 mL) and octadecyl(trimethoxy)silane (5.66 mL) were added to the flask. The flask was transferred to an oil bath and the reaction was allowed to proceed at 50° C. for 48 h. After completion of the reaction, the reaction mixture was filtered and dried with nitrogen gas to give the desired een-MOF/Al—Si as a spherical light brown solid. In the een-MOF/Al—Si, silicon (Si) was uniformly distributed on the surface of the spherical composite.

### Experimental Example 1. Measurement of Contact Angles of the Een-MOF/Al Coated with Hydrophobic Silanes with Different Carbon Chain Lengths

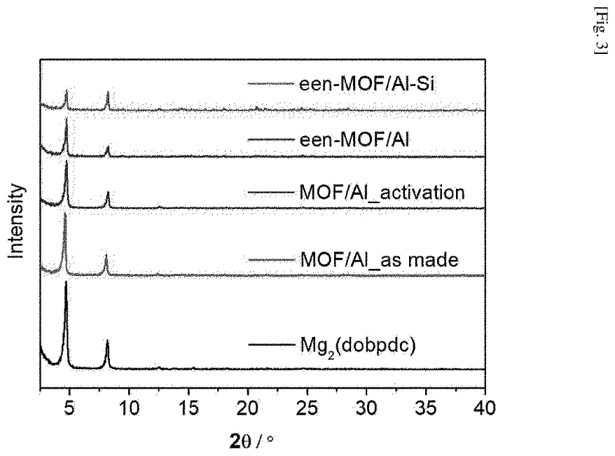

The een-MOF/Al was coated with various silanes shown in FIG. 2 and the contact angles of the silane-coated een-MOF/Al for water were measured to determine an optimal silane introduced to the surface of the composite. The results are shown in FIG. 2. The hydrophobic properties of the composite were effectively maintained from when the number of carbon atoms was 6 (i.e. hexyl(trimethoxy)silane). The een-MOF/Al—Si containing octadecyl(trimethoxy)silane having 8 carbon atoms was used for subsequent experiments.

### Experimental Example 2. Basic Characterization of the Een-MOF/Al—Si

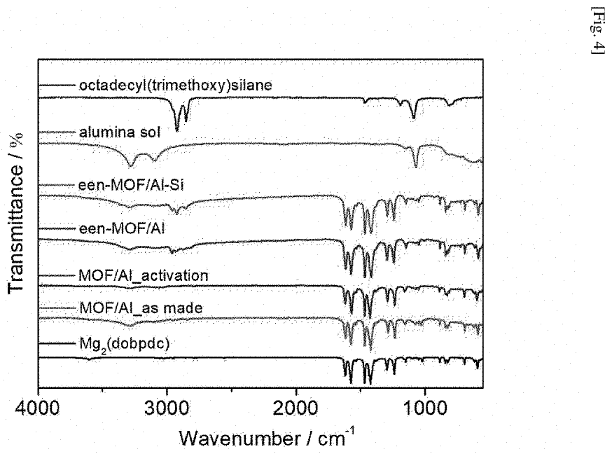

The basic characteristics of the een-MOF/Al—Si prepared in Example 1 were analyzed. The results are shown in FIGS. 3-6.

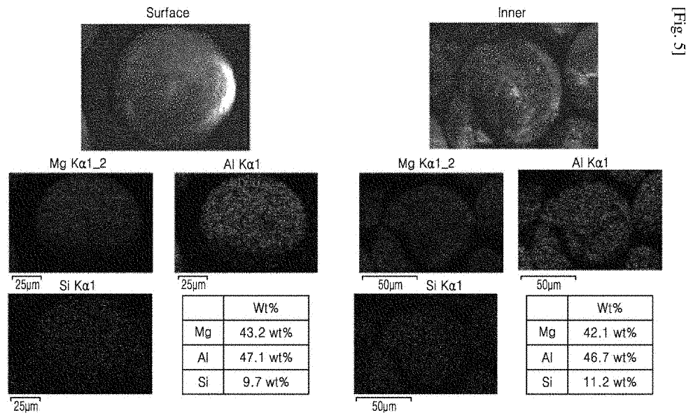

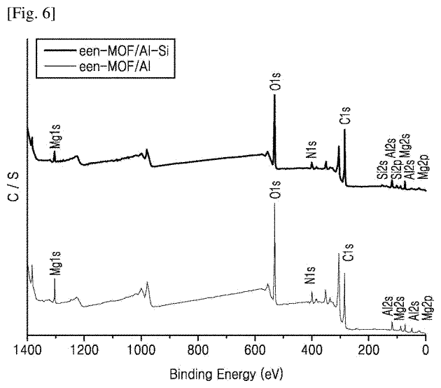

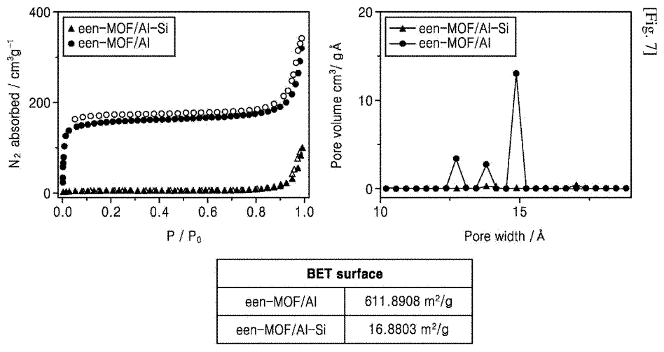

Specifically, FIG. 3 shows a PXRD pattern of the amine-functionalized porous metal-organic framework/alumina composite surface coated with the hydrophobic silane (een-MOF/Al—Si), FIG. 4 shows an IR spectrum of the amine-functionalized porous metal-organic framework/alumina composite surface coated with the hydrophobic silane (een-MOF/Al—Si), FIG. 5 shows surface (left) and cross-sectional (right) SEM-EDS images of the amine-functionalized porous metal-organic framework/alumina composite surface coated with the hydrophobic silane (een-MOF/Al—Si), and FIG. 6 shows the results of XPS analysis for the amine-functionalized porous metal-organic framework/alumina composite surface coated with the hydrophobic silane (een-MOF/Al—Si).

The PXRD patterns shown in FIG. 3 reveal that the main peaks of the Mg₂(dobpdc) were kept even after amine functionalization and silane introduction. In the IR spectra shown in FIG. 4, the peaks corresponding to N—H stretching in the range of 3000-3300 cm⁻¹ indicate effective amine functionalization and the increased intensities of the peaks corresponding to C—H stretching at 300 cm⁻¹ indicate successful introduction of the hydrophobic silane. The results of SEM-EDS (FIG. 5) and XPS (FIG. 6) reveal that Si was present on the surface and inside the composite and the spherical shape of the composites was maintained well even after silane introduction.

### Experimental Example 3. Analysis of Gas Adsorption Capacity of the Een-MOF/Al—Si

The gas adsorption capacity of the een-MOF/Al—Si prepared in Example 1 was analyzed. FIG. 7 shows nitrogen adsorption isotherms of the een-MOF/Al and the een-MOF/Al—Si at 77K. Changes in the pore size and surface area of the een-MOF/Al—Si were measured based on the nitrogen adsorption isotherms. As shown in FIG. 7, most of the micropores of the MOF disappeared when the hydrophobic silane was introduced to the surface of the composite. This is believed to be because the long carbon chain of the silane blocked the micropores.

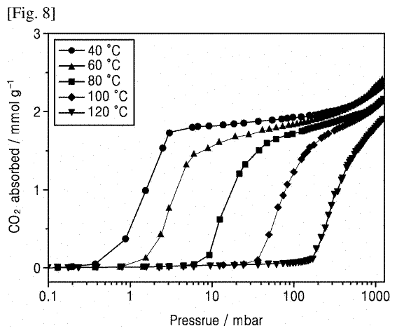

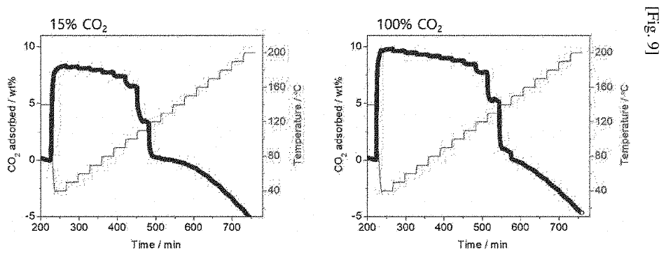

Next, the carbon dioxide adsorption isotherms of the een-MOF/Al—Si were measured with increasing temperature from 40 to 120° C. The results are shown in FIG. 8. The een-MOF/Al—Si adsorbed 1.94 mmol/g, 1.86 mmol/g, 1.76 mmol/g, 1.50 mmol/g, and 0.09 mmol/g of carbon dioxide at 40° C., 60° C., 80° C., 100° C., and 120° C., respectively, at 150 mbar, which is the average partial pressure of carbon dioxide in flue gas from thermal power plants. These results correspond to the general tendency of carbon dioxide adsorbents to absorb a small amount of carbon dioxide with increasing temperature. The een-MOF/Al—Si was found to adsorb 1.5 mmol/g of carbon dioxide at 40-80° C., which demonstrates its high carbon dioxide adsorption performance.

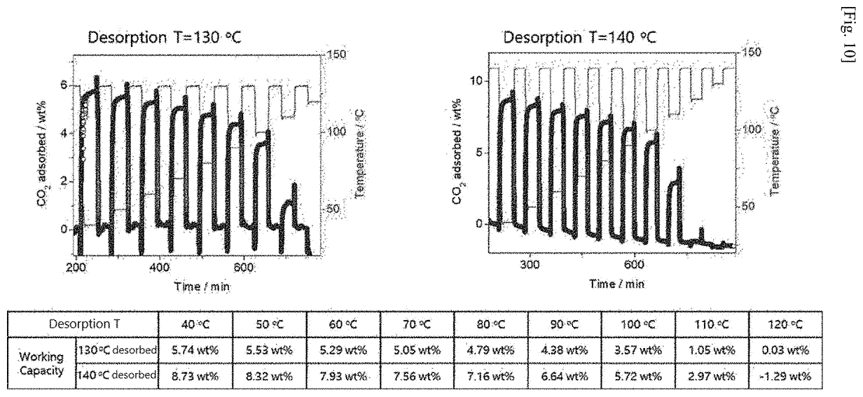

Next, an experiment was conducted to find a suitable temperature for adsorption of carbon dioxide at a concentration of 15% by the een-MOF/Al—Si and a suitable temperature for desorption of carbon dioxide at a concentration of 100% from the een-MOF/Al—Si. The results are shown in FIG. 9. The een-MOF/Al—Si was found to adsorb carbon dioxide (≥7 wt %) at a concentration of 15% at less than 90° C. and desorb carbon dioxide at a concentration of 100% at 130-140° C.

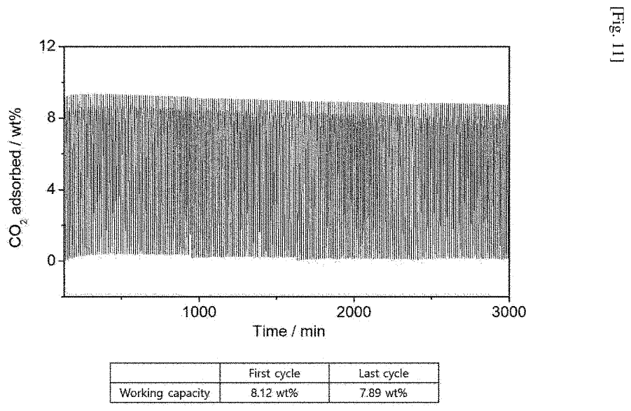

Next, the adsorption performance of the een-MOF/Al—Si was investigated in more detail. To this end, carbon dioxide adsorption isotherms of the een-MOF/Al—Si at 313-393K were measured. The results are shown in FIG. 10. The most suitable temperature for desorption of carbon dioxide from the een-MOF/Al—Si was 140° C. The een-MOF/Al—Si showed the best adsorption performance (7.56 wt %) at 80° C.

Next, the long-term adsorption performance of the een-MOF/Al—Si was investigated. To this end, the long-term adsorption performance at an adsorption temperature of 80° C. and a desorption temperature of 140° C. was analyzed. The results are shown in FIG. 11. A total of 300 cycles consisting of adsorption for 5 min and desorption for 1 min were performed. The adsorption capacity was initially 8.12 wt % and decreased to 7.89 wt % after 300 cycles. This was caused because the amine lost its ability to functionalize the composite. The een-MOF/Al—Si is believed to recover its adsorption performance when the amine is re-functionalized.

### Experimental Example 4. Evaluation of Water Stability of the Een-MOF/Al—Si

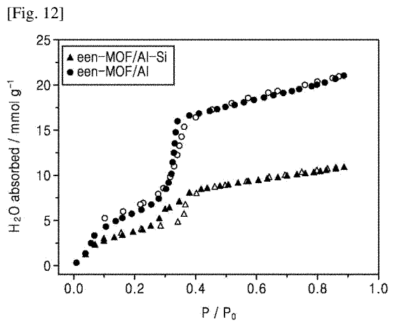

First, water adsorption isotherms of the een-MOF/Al before silane introduction and the een-MOF/Al—Si after silane introduction were measured. The results are shown in FIG. 12. The results reveal that the water adsorption performance of the composite surface coated with the hydrophobic silane (een-MOF/Al—Si) was significantly lower than that of the uncoated composite een-MOF/Al.

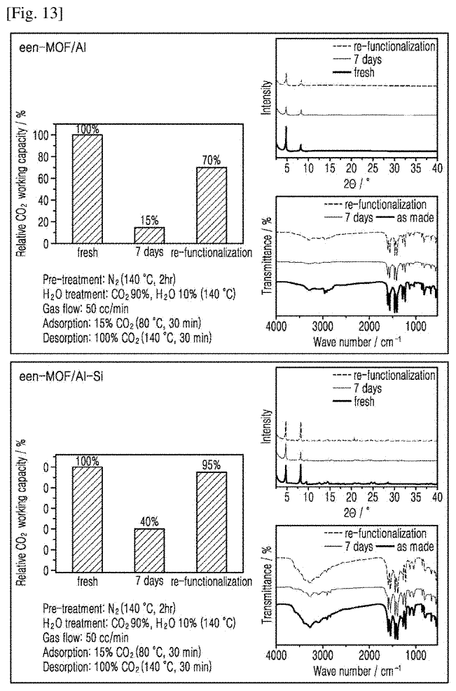

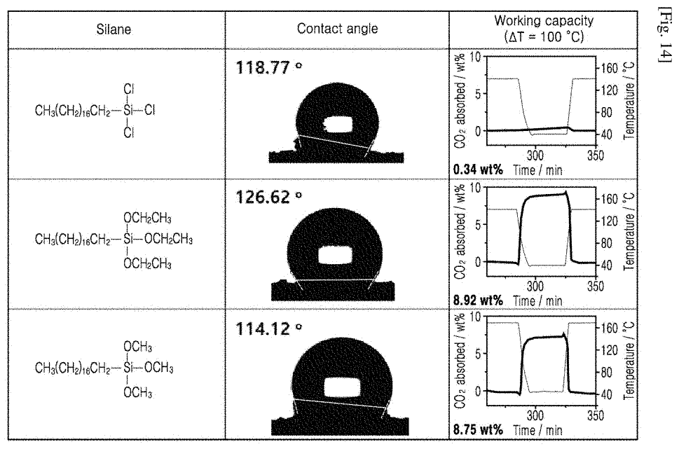

Based on these results, an experiment was conducted to evaluate the long-term water stability of the composite surface coated with the hydrophobic silane (een-MOF/Al—Si). The results are shown in FIG. 13. The results reveal that the adsorption capacity of the uncoated composite (een-MOF/Al) was greatly reduced by ≥80% during the long-term experiment and was not fully recovered even when the amine was re-functionalized. The PXRD patterns of the een-MOF/Al reveal that the crystallinity of the een-MOF/Al was greatly decreased. The IR spectra of the een-MOF/Al reveal that the amine lost its ability to functionalize the composite when the temperature was kept constant at 140° C.

In contrast, the adsorption capacity of the composite surface coated with the hydrophobic silane (een-MOF/Al—Si) was reduced by ˜30% during the long-term experiment and was recovered when the amine was re-functionalized. The PXRD patterns of the een-MOF/Al—Si reveal that high crystallinity of the een-MOF/Al—Si was maintained. From these results, it can be concluded that the surface introduction of the hydrophobic silane leads to a significant improvement in the long-term water stability of the een-MOF/Al—Si.

### Experimental Example 5. Analysis of Adsorption Capacities of Composites Coated with Hydrophobic Silanes with Different Functional Groups (Een-MOF/Al—Si)

Each of the hydrophobic silanes shown in FIG. 14 was introduced to the surface of the een-MOF/Al. The contact angles and adsorption capacities of the composites coated with the hydrophobic silanes (een-MOF/Al—Si) were analyzed. The results are shown in FIG. 14. When the functional group was chlorine (Cl), the adsorption capacity was remarkably low. In contrast, when the functional group was methoxy (OCH₃) or ethoxy (OCH₂CH₃), the coated composite well maintained its hydrophobicity and showed high adsorption performance.

### INDUSTRIAL APPLICABILITY

The carbon dioxide adsorbent of the present invention can effectively reduce the amount of energy required for regeneration after adsorption and desorption of carbon dioxide and maintain its structural stability against water present in flue gas, thus being effective in capturing carbon dioxide in a real fluidized bed. Therefore, the carbon dioxide adsorbent of the present invention can find useful applications in related fields.

1. A carbon dioxide adsorbent comprising an amine-functionalized metal-organic framework (MOF)/alumina composite comprising an amine-functionalized porous MOF and aluminum oxide (Al₂O₃) bound to the metal ions of the amine-functionalized porous MOF wherein the surface of the composite is coated with a hydrophobic silane.

2. The carbon dioxide adsorbent according to claim 1, wherein the porous metal-organic framework is selected from the group consisting of M₂(dobpdc), M₂(dobdc), M₂(m-dobdc), M₂(dondc), and M₂(dotpdc) where M is Mg, Ti, V, Cr, Mn, Fe, Co, Ni, Cu or Zn, dobpdc is 4,4′-dioxido-3,3′-biphenyldicarboxylate, dobdc is 2,5-dioxido-1,4-benzenedicarboxylate, m-dobdc is 4,6-dioxido-1,3-benzenedicarboxylate, dondc is 1,5-dioxide-2,6-naphthalenedicarboxylate, and dotpdc is 4,4′-dioxido-3,3′-triphenyldicarboxylate.

3. The carbon dioxide adsorbent according to claim 1, wherein the amine is represented by Formula 1: 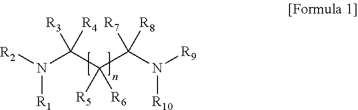
wherein R₁ to R₁₀ are each independently hydrogen or (CH₂)ₘ—CH₃, n is an integer from 1 to 20, and each m is independently an integer from 0 to 20, or Formula 2: 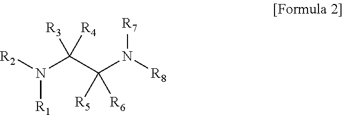
wherein R₁ to R₈ are each independently hydrogen or (CH₂)ₘ—CH₃ and each m is independently an integer from 0 to 20.

4. The carbon dioxide adsorbent according to claim 3, wherein the amine is ethylenediamine, 1-methylethylenediamine, 1,1-dimethylethylenediamine or N-ethylethylenediamine.

5. The carbon dioxide adsorbent according to claim 1, wherein hydrophobic silane is represented by Formula 3: 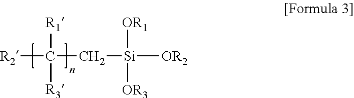
wherein R₁ to R₃ and R₁′ to R₃′ are each independently hydrogen or (CH₂)ₘ—CH₃ and n and m are each independently an integer from 0 to 20.

6. The carbon dioxide adsorbent according to claim 5, wherein the hydrophobic silane is selected from the compounds represented by Formulae 4 to 9: 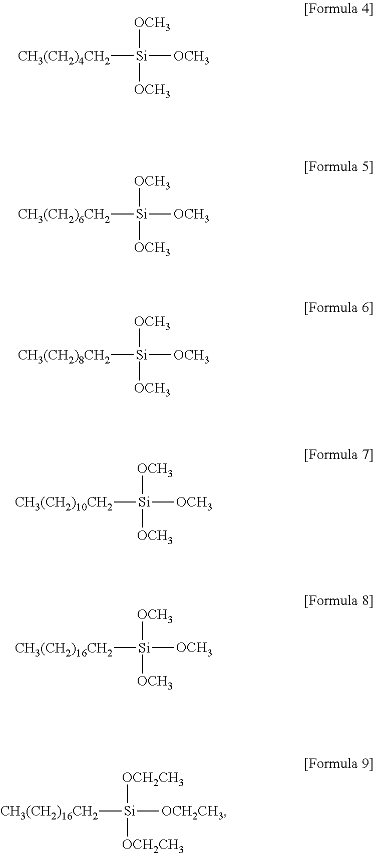
and mixtures thereof.

7. The carbon dioxide adsorbent according to claim 1, wherein the hydrophobic silane is coated in an amount corresponding to a weight ratio of 3:1 to 10:1 to the composite.
